(19) United States
(12) Patent Application Publication
(10) Pub. No.: US 2015/0368879 A1
(43) Pub. Date: Dec. 24, 2015

(54) Combined Hydraulic Implement and Propulsion Circuit with Hybrid Energy Capture and Reuse

(71) Applicant: Caterpillar Inc., Peoria, IL (US)

(72) Inventors: Jeremy Peterson, Washington, IL (US); Jeffrey Kuehn, Germantown Hills, IL (US); Michael Knussman, East Peoria, IL (US)

(21) Appl. No.: 14/313,239

(22) Filed: Jun. 24, 2014

(51) Int. Cl. E02F 9/22; E02F 3/42; F15B 11/17; F15B 1/027; F15B 13/08

(52) U.S. Cl. CPC E02F 9/2292; F15B 1/027; F15B 13/08; F15B 11/17; E02F 3/422; F15B 2201/00; F15B 2211/20576; F15B 2211/61

(57) ABSTRACT

An integrated implement actuation and propulsion system for a machine is provided. The system may include: an implement circuit including a first pump and at least one hydraulic implement; a propulsion circuit including a second pump; a hydraulic motor; a brake valve; a back pressure valve; and a combiner valve connected to both the implement circuit and the propulsion circuit, the combiner valve being configured to effect selective fluid communication between the implement circuit and the propulsion circuit.

### TECHNICAL FIELD

The present disclosure relates generally to a hydraulic system for a machine, and more particularly to an integrated implement actuation and propulsion system for a machine, and even more particularly to a construction machine such as a wheel loader.

### BACKGROUND

Machines such as, for example, self-propelled construction machines, having a hydrostatic drive system are generally exposed to extreme fluctuations with regard to the load to be handled and with regard to the machine speed to be realized. The internal combustion engine providing the requisite drive power for the hydrostatic drive system, and for other hydraulic power consumers, such as, hydraulic implements, is generally driven at a constant engine speed at which the internal combustion engine operates most efficiently. Only in case the requisite drive power and/or the requested power supply of the hydraulic consumers increases, the engine speed of the internal combustion engine may have to be increased.

Known machines having a hydrostatic drive system often include a closed circuit travel system. Such closed circuit travel systems require a large travel pump to generate sufficient flow of a hydraulic fluid during high-speed travel. Machines, such as, for example, wheel excavators or other wheeled construction machines as e.g. wheel dozers, wheel loaders, wheel tractor-scrapers, underground mining machines, skid steer loaders, skidders, road reclaimers, industrial loaders, wheel compactors, feller bunchers, may be operated quite often in a low- or medium-speed travel mode, but quite rarely in a high-speed travel mode. Hence, such hydraulic drives for machines, which, for a major operating time, are traveled in a low or medium travel speed mode, comprise an oversized hydraulic pump for the travel system, which may result in high manufacturing costs, and which may have a negative impact on the requisite space within the machine, and which may negatively impact the performance of the machine.

One approach to overcome the disadvantages of using an oversized hydraulic pump in a closed system is to create a single open hydraulic circuit that combines different hydraulic functions of the machine. This approach of using a combined open hydraulic circuit allows for smaller sized hydraulic pumps to be used in a machine. However, combined open hydraulic circuits often have poor braking characteristics. Furthermore, the combined open hydraulic circuit loses kinetic energy at certain points in the circuit.

Different strategies have been employed to make hydraulic circuits for working machines such as wheel loaders more efficient. For example, U.S. Patent Publication No. 2013/0061588 (“Jagoda”) published on Mar. 14, 2013 purports to describe a hydraulic system for an excavator that recovers some inertial energy lost by using an accumulator. The accumulator stores energy lost during deceleration of a load connected to the input/output shaft of the motor and releases energy from the accumulator during acceleration of the input/output shaft of the motor. Jagoda, however, does not disclose a combined hydraulic system that integrates the propulsion system and the implement system of a machine.

While conventional combined hydraulic systems for machines are useful to some extent, there remains a need to provide a low cost, smaller, and more efficient integrated implement and propulsion hydraulic circuit, which corresponds to engine size and capabilities. Accordingly, the presently disclosed hydraulic system and methods of assembling and operating a hydraulic system for a machine is directed at overcoming one or more of the disadvantages in currently available machines with hydraulic systems.

The present disclosure is directed, at least in part, to improving or overcoming one or more aspects of conventional systems.

### SUMMARY OF THE DISCLOSURE

In accordance with one aspect of the disclosure, a hydraulic system for a machine, includes: an implement circuit including: a first pump configured to provide a hydraulic fluid to the implement circuit; and at least one hydraulic implement configured to be operated by the hydraulic fluid; and a propulsion circuit including: a second pump configured to provide the hydraulic fluid to the propulsion circuit; a hydraulic motor operably connected to the second pump; a brake valve operably connected to the second pump, the brake valve configured to adjust an amount of the hydraulic fluid provided to the hydraulic motor; a back pressure valve operably connected to the brake valve and the hydraulic motor, the back pressure valve being configured to restrict an amount of the hydraulic fluid flowing from the hydraulic motor and through the back pressure valve to increase a pressure at an inlet to the back pressure valve and an outlet of the hydraulic motor during a deceleration condition; and a combiner valve connected to both the implement circuit and the propulsion circuit, the combiner valve being configured to effect selective fluid communication between the implement circuit and the propulsion circuit.

In accordance with another aspect of the disclosure, a hydraulic system for a machine is provided. The system may include: an implement circuit including: a first pump configured to provide hydraulic fluid to the implement circuit; at least one hydraulic implement configured to be operated by the hydraulic fluid; a propulsion circuit including: a second pump configured to provide the hydraulic fluid to the propulsion circuit; a hydraulic motor operably connected to the second pump; a brake valve operably connected to the second pump, the brake valve configured to adjust an amount of hydraulic fluid provided to the hydraulic motor; a back pressure valve operably connected to the brake valve and hydraulic motor, the back pressure valve configured to restrict an amount of the hydraulic fluid flowing from the hydraulic motor and through the back pressure valve of fluid to increase a pressure at an inlet to the back pressure valve and an outlet of the hydraulic motor during a deceleration condition; an accumulator operatively connected to the implement and propulsion circuits and configured to store the hydraulic fluid from at least one of the implement and propulsion circuits, wherein the accumulator is operatively connected to an engine starting device to provide hydraulic fluid to the engine starting device to rotate the engine starting device to thereby rotate a driveshaft attached to at least one of the first and second pumps and rotation of the driveshaft will cause an engine associated with the machine to start; and a combiner valve connected to both the implement circuit and the propulsion circuit, the combiner valve being configured to effect selective fluid communication between the implement circuit and the propulsion circuit.

In accordance with another aspect of the disclosure, a machine having a hydraulic system may be provided. The system may include: an implement circuit including: a first pump configured to provide hydraulic fluid to the implement circuit; at least one hydraulic implement configured to be operated by the fluid; a propulsion circuit including: a second pump configured to provide the fluid to the propulsion circuit; a hydraulic motor operably connected to the second pump; a brake valve operably connected to the second pump, the brake valve configured to adjust an amount of hydraulic fluid provided to the hydraulic motor; a back pressure valve operably connected to the brake valve and hydraulic motor, the back pressure valve configured to restrict an amount of the hydraulic fluid flowing from the hydraulic motor and through the back pressure valve to increase a pressure at an inlet to the back pressure valve and an outlet of the hydraulic motor in a deceleration condition; an accumulator operatively connected to the implement and propulsion circuits and configured to store fluid flowing out of a cylinder associated with at least one hydraulic implement as the at least one hydraulic implement is lowered; and a combiner valve connected to both the implement circuit and the propulsion circuit, the combiner valve being configured to effect selective fluid communication between the implement circuit and the propulsion circuit.

### BRIEF DESCRIPTION OF THE DRAWINGS

FIG. 1 is a side view of a machine configured to travel by means of an integrated implement actuation and propulsion system constructed in accordance with the teachings of the present disclosure.

FIG. 2 is a schematic diagram of a hydraulic system for a machine constructed in accordance with the teachings of the present disclosure.

FIG. 3 is a schematic diagram of an integrated implement propulsion system including a drive train energy storage device for a machine constructed in accordance with the teachings of the present disclosure.

FIG. 4 is a schematic diagram of an integrated implement propulsion system including means for charging the energy storage device by lowering an implement in accordance with the present disclosure.

FIG. 5 is a schematic diagram of an integrated implement propulsion system including a pump configured to receive high-pressure fluid in accordance of the present disclosure.

### DETAILED DESCRIPTION

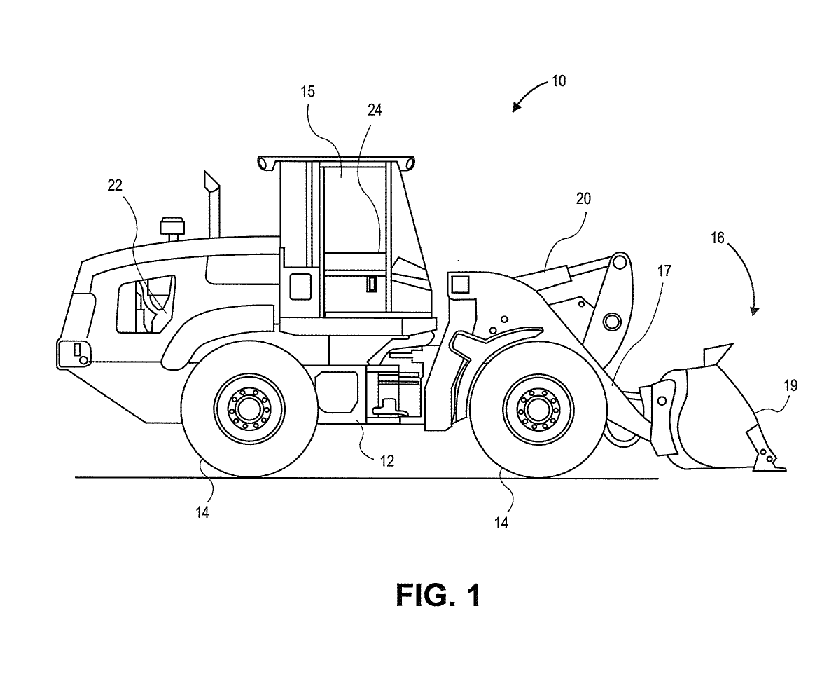

Referring now to the drawings, and with specific reference to FIG. 1, a machine constructed in accordance with the teachings of this disclosure is generally referred to by reference numeral 10. While the machine 10 is depicted as a wheel loader in FIG. 1, it is to be understood that the teachings of this disclosure apply with equal efficacy to many other machines or vehicles including, but not limited to, track-type loaders, excavators, motor graders, skid steers, compactors, scrapers, pipelayers, rippers, and the like.

As shown in FIG. 1, the loader 10 may include a chassis 12 supporting an engine 22, and being supported by wheels 14. The chassis 12 may also support an operator station 15, and an implement 16 or multiple implements 16. The implements 16 may include a lift arm 17 (or pair of lift arms) 17 hinged to the chassis 12. A bucket (or other implement) 19 may be provided on the lift arm 17. While not depicted, it is to be understood that an array of implements 16 with such a loader 10 are possible including, but not limited to, blades, forks, and multiple varieties of buckets such as toothed buckets, ejector buckets, side dump buckets, demolition buckets, and the like.

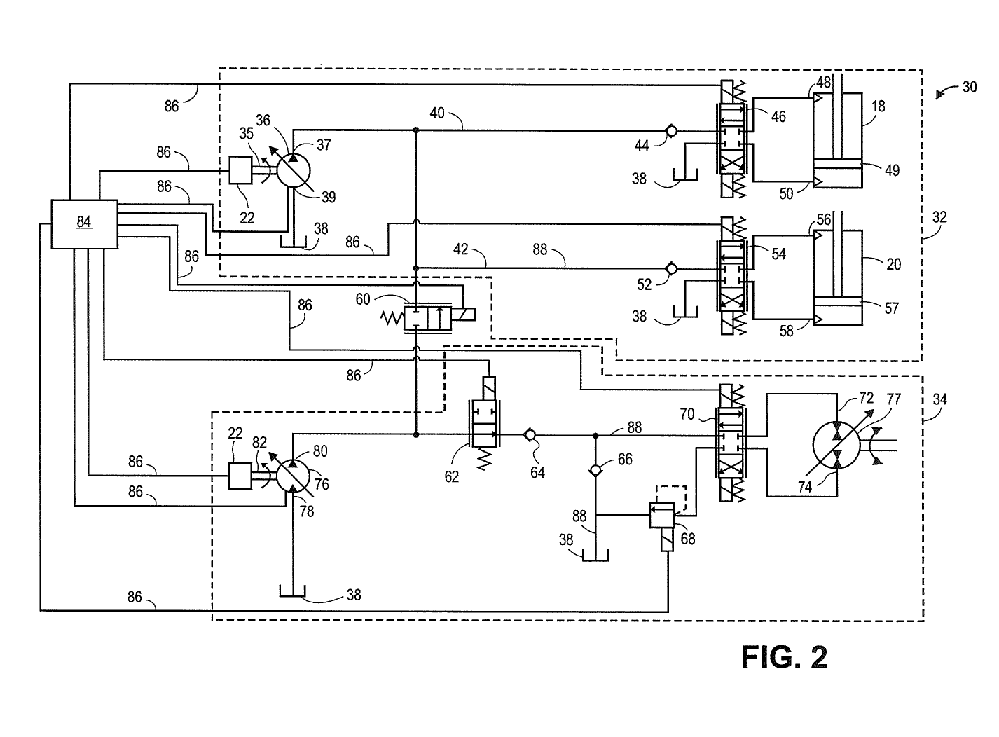

In order to raise and lower the lift arm 17, a lift cylinder 18 (hidden from view behind the front wheels of the machine 10 in FIG. 1 but represented in FIGS. 2-5) may operatively connect the chassis 12 to the lift arm 17. Typically, a lift cylinder 18 is provided for each lift arm 17. The lift cylinder 18 is a hydraulic cylinder connected to the hydraulic system or circuit 30 (shown in FIGS. 2-5) of the loader 10 as will be described in further detail herein. Similarly, in order to rotate the bucket 19 relative to the lift arm 17, one or more tilt cylinders 20 may operatively connect the bucket 19 to the chassis 12. Again, the lift cylinder 18 and tilt cylinders 20 are connected to the hydraulic circuit 30 of the loader 10 as will be described in further detail herein.

The wheel loader 10 as shown in FIG. 1 may be equipped with a hydraulic circuit 30 as shown in FIG. 2. The hydraulic circuit 30 may be operatively connected to, and controlled by, a controller 84. In some embodiments, the controller 84 may be a microcontroller or at least include a microcontroller. The controller 84 may also include a database operatively connected to the controller which may include computer programs configured to be processed by the controller 84. The controller 84 may also include or be part of a computer. The connections 86 which connect the controller 84 to various components in the circuit 30 may include both wired and wireless connections. Any suitable connection that can convey data to and from the controller 84 may be used in accordance with the present disclosure.

The hydraulic circuit 30 may include an implement circuit 32 and a drive circuit 34. The implement circuit 32 provides components to drive the implement 16. In the embodiment shown in the figures, the implement 16 is a bucket 19 that is controlled by a lift cylinder 18 and a tilt cylinder 20. The lift cylinder 18 lifts the bucket 19 and the tilt cylinder 20 articulates the bucket 19 to selectively retain or dump its contents. The implement circuit 32 has a hydraulic pump 36 which may be referred to in this document as the pump 36. The pump 36 is operably connected to at least one hydraulic implement 16, such as a lift cylinder 18 and a tilt cylinder 20. Other hydraulic implements, however, are also contemplated for use.

A lift valve 46 may be operably connected to the lift cylinder 18 such that when the lift valve 46 is activated, hydraulic fluid flows from the hydraulic pump 36 to the lift cylinder 18. A check valve 44 may be positioned upstream of the lift valve 46 to ensure hydraulic fluid flow from the hydraulic pump 36 flows to the lift valve 46 toward lift valve 46 the but not in a reverse direction.

The lift cylinder 18 has two ports 48 and 50. Each port is located on either side of the piston 49 so that when fluid enters port 48 the piston 49 moves towards port 50, and when fluid flows into port 50 the piston 49 will move towards port 48. As fluid flows into one of ports 48 and 50 fluid will flow out of the opposite of ports 48 and 50. Control of which port 48 and 50 fluid flows into is accomplished by the position of the lift valve 46. The lift valve 46 as shown in FIG. 2 has three positions. When the lift valve 46 is in a first position, fluid flows into port 48 and out of port 50. When the lift valve 46 is in a second position (the position shown in FIG. 2) no fluid flows into or out of ports 48 and 50. When the lift valve 46 is in a third position, fluid flows into port 50 and out of port 48. One of ordinary skill in the art will recognize that the valve 46 can be in intermediate positions between the first and second positions or between the second and third positions which throttle the amount of flow through the valve 46. These intermediate positions will generally allow fluid to flow (in a reduced amount) as described with respect to the first or third positions. In some embodiments, when fluid flows out of the lift cylinder 18 and back through the lift valve 46 the fluid may be returned to the sump or low-pressure reservoir 38.

The tilt cylinder 20 has two ports 56 and 58. Each port 56, 58 is located on either side of this piston 57 so that when fluid enters port 56, the piston 57 moves towards port 58 and when fluid flows into port 58, the piston 57 will move towards port 56. Control of which port 56 and 58 fluid flows into is accomplished by the position of the tilt valve 54. The tilt valve 54 as shown in FIG. 2 has three positions. In a first position, fluid flows into port 56 and out of port 58. In a second position, (shown in FIG. 2) no fluid flows into or out of ports 56 and 58. In a third position, fluid flows into port 58 and out of port 56. One of ordinary skill in the art will recognize that the valve 54 can be in an intermediate position between positions one and two or between positions two and three when the valve 54 is in the intermediate positions the amount fluid flowing through the valve 54 will be throttled. These intermediate positions will general allow fluid to flow (in a reduced amount) as described with respect to the first and third positions. In some embodiments, when fluid flows out of the lift cylinder 18 and back through the lift valve 46 the fluid may be returned to the sump 38 (which may also be referred to as a reservoir 38).

The hydraulic pump 36 may be driven by an engine 22 associated with the machine 10. In the schematic diagrams of FIGS. 2 through 5 the engine 22 is shown to connect to the pump 36 by a driveshaft 35 although any suitable type connection will be in accordance the present disclosure and a direct connection with a driveshaft 35 is not required. The engine 22 may be an internal combustion engine, turbine engine, or any other suitable type engine. The hydraulic pump 36 may be a variable displacement pump or a fixed displacement pump. According to an aspect of the disclosure, a lift cylinder 18 and tilt cylinder 20 may be arranged in parallel within the implement circuit 32 as shown in FIG. 2. The hydraulic pump 36 may operate the lift cylinder 18 and the tilt cylinder 20 simultaneously. The hydraulic pump 36 may also operate the lift cylinder 18 and the tilt cylinder 20 independently from each other as needed.

The propulsion circuit 34 includes a hydraulic pump 76. The numbering of the pumps herein is meant to merely be a reference for distinguishing between various pumps and is not intended to be limiting but rather an identifier and a convenience to the reader. The pump 76 may be operably connected to the engine 22 via a drive shaft 82 similar to that described above with respect to the pump 36. The pump 76 is operatively connected to the hydraulic motor 77 that propels the machine 10. Pump 76 is fluidly connected to the sump 38 so that as the pump 76 is running it can draw fluid from the sump 38 into the inlet 78 and out the outlet 80. The pump 76 is operatively connected to the controller 84 via the controller connection 86.

A directional valve 70 is located in the drive circuit 34 between the hydraulic motor 77 and the pump 76. The directional valve 70 can achieve at least 3 positions. In a first position, fluid from the pump 76 enters the port 72 to move the hydraulic motor 77 in a first direction. In a second position, the position shown in FIG. 2, the directional valve 70 is in a position where no hydraulic fluid enters or exits ports 72 and 74 of the hydraulic motor 77. In a third position fluid from the pump 76 enters the hydraulic motor 77 through port 74 and exits out of port 72 to operate the hydraulic motor 77 in a second direction. Those of ordinary skill in the art after reviewing this disclosure will understand that the directional valve 70 can also be in a variety of positions between the first and second position to throttle or reduce the amount of fluid that comes into the hydraulic motor 77. Further, the directional valve 70 can also be in a variety of positions between the second and third position described above which would throttle the amount of fluid coming from the pump 76 into port 74 and out of port 72 to run the hydraulic motor 77 in the second direction at a variety of speeds.

Thus, the controller 84, by controlling via the controller connection 86, can control the directional valve 70 to control the speed and direction of the hydraulic motor 77.

In some embodiments, the drive circuit 34 is an open loop. The drive circuit 34 can have some features which will allow the drive circuit 34 to conduct a braking function with respect to the hydraulic motor 77. In order to provide a braking function for the hydraulic motor 77, a back pressure valve 68, a motor makeup valve 66, and a brake valve 62 may be present in the drive circuit 34. After fluid exits the hydraulic motor 77 and returns through the directional valve 70 the fluid may flow into the back pressure valve 68. The back pressure valve 68 may be controlled by the controller 84 and be operatively connected to the controller 84 via the controller connection 86. The back pressure valve 68 is capable of being set into a variety of positions which can relieve or create pressure within the drive circuit 34 between the back pressure valve 68 and the hydraulic motor 77. When the back pressure valve 68 moves to position which decreases fluid resistance and therefore allows fluid to flow more freely through the back pressure valve 68, pressure upstream of the back pressure valve 68 in the direction toward the directional valve 70 will be relieved. When the back pressure valve 68 moves in a position which increases fluid resistance and therefore impede or throttle a fluid flow through the back pressure valve 68, pressure will increase upstream of the back pressure valve 68 in the direction of the directional valve 70.

The motor makeup valve 66 may be a check valve that prevents fluid from flowing through the valve 66 toward the back pressure valve 68 or the reservoir 38. The motor makeup valve 66 will allow fluid to flow only in the direction from the back pressure valve 68 toward the load check valve 64 or directional valve 70. In some embodiments, the fluid may also flow from the back pressure valve 68 towards the sump 38 as well as through the motor makeup valve 66. The motor makeup valve 66 will allow the hydraulic motor 77 to draw fluid from the sump 38 if the hydraulic motor 77 needs additional fluid. Additional hydraulic fluid may be needed if more fluid exits the hydraulic motor 77 then comes in via the pump 76. Thus the motor makeup valve 66 allows for additional fluid to enter the drive circuit 34 from the sump 38 if needed. However, in some embodiments, fluid cannot flow back to the sump 38 through the motor makeup valve 66.

A brake valve 62 may also be present in the propulsion circuit 34 as shown. The brake valve 62 may be controlled by the controller 84 via controller connection 86. The brake valve 62 can move in a number of positions between a fully open position and a fully shut position. When fully open, fluid from pump 76 flows through the brake valve 62 toward the hydraulic motor 77. If it is desired to brake the machine 10 quickly, this braking operation can be done not only by braking the wheels 14 in a conventional manner, but braking may also occur in the hydraulic motor 77 itself. Braking the motor 77 via fluid resistance through the brake valve 62 can provide the benefit of reducing stress and strain on a wheel braking systems. The brake valve 62 can move from an open position to a shut position to block fluid flow to the motor 77. It is faster to use a brake valve 62 to block fluid flow than simply disengaging the pump 76 from the motor 77 because of a wind down period it takes for the pump 76 to stop. Inserting a brake valve 62 can more quickly and positively block fluid flow to provide a brake function to the motor 77. Thus, the combination of the back pressure valve 68 the motor makeup valve 66 and the brake valve 62 allows a brake function to be provided to the hydraulic motor 77. Using the combiner valve 60 to block fluid communication between the implement circuit 32 and the drive circuit 34 will allow the implement 16 to be used during a braking operation. Closing the combiner valve 60 can also isolate the implement circuit 32 and the propulsion circuit 34 to reduce throttling when fluid requirements for each circuit 32 and 34 is satisfied by their respective pumps 36 and 76. In some embodiments the combiner valve 60 may be a proportional 2-port/2-way valve, an on/off valve or any other suitable valve.

In some instances, it may be desirable to provide pressurized fluid from the implement circuit 32 to the drive circuit 34 and vice versa. For example, in some instances the implement 16 may require more pressurized fluid that is available from pump 36 or the hydraulic motor 77 may require more fluid than is available from the pump 76. In such instances, the combiner valve 60 may move to an open position thereby allowing pressurized fluid from the implement circuit 32 to flow into the drive circuit 34 and vice versa. The combiner valve 60 may be operatively connected to the controller 84 via the controller connections 86 and may be available to move in a variety of positions between a fully closed and fully opened.

The combiner valve 60 allows pumps 36 and to 76 to be sized smaller than what they would need to be sized if the two circuits 32 and 34 were isolated from each other. Because the two circuits, 32 and 34 are not isolated, the capacity of both pumps 36,76 may be used if there is a large demand in one of the circuits 32 and 34. If no combiner valve 60 were present, then the pump 76 would need to be sized for the largest conceived flow required by the implement 16. Likewise the pump 76 would need to be sized for the largest conceived flow to the motor 77 may require. However by having a combiner valve 60, the pump 36 may be reduced because if the implement 16 requires additional capacity greater than pump 36, then pump 76 can be used to assist by sending fluid through the combiner valve 60. The same is true for the pump 76. The pump 76 may be sized slightly smaller than a maximum need of the motor 77 because when the motor 77 needs more pressurized fluid than available from the pump 76 the combiner valve 60 can open and the motor 77 can receive additional pressurized fluid from the pump 36.

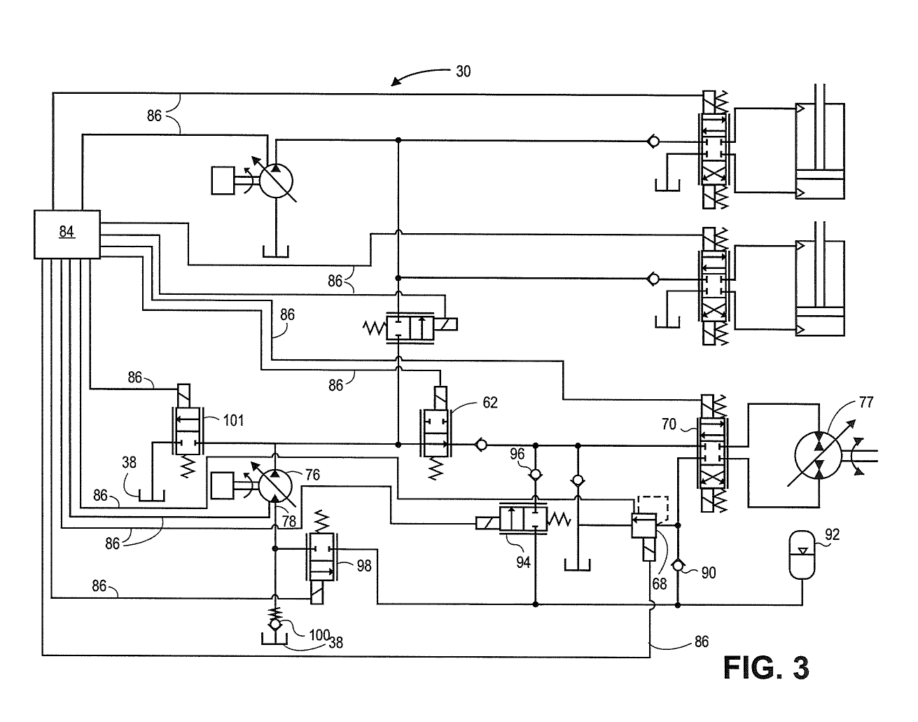

FIG. 3 illustrates a hydraulic circuit 30 in accordance with another embodiment of the disclosure. The circuit 30 shown in FIG. 3 is similar to that shown and described with respect to FIG. 2. However the circuit 30 shown in FIG. 3 includes additional components providing additional features and capabilities. The additional features and capabilities will be described below however those features and capabilities already described with respect to FIG. 2 will not be described again for the sake of brevity.

A drive train hybrid energy storage device 92 also referred to as an accumulator 92 is added to the hydraulic circuit 30. In some embodiments, the accumulator 92 is configured to store hydraulic fluid at pressure. Pressurized fluid discharged from the hydraulic motor 77 can flow through the back pressure valve 68 as previously described or, depending upon the pressure level set by the back pressure valve 68, the fluid can also flow into the energy storage device or accumulator 92.

A check valve 90 can be installed in the circuit 30 between the accumulator 92 and back pressure valve 68 to ensure that fluid from the accumulator 92 does not flow through the back pressure valve 68.

A launch assist valve 94 may be located in the circuit 30. The launch assist valve 94 may be operatively connected to the controller 84 via the controller connections 86. The launch assist valve 94 can operate between two positions. In one position the launch assist valve 94 blocks the flow of fluid therethrough. In the other position the launch assist valve 94 allows fluid to flow therethrough. Those of ordinary skill in the art after viewing this disclosure will understand that in some embodiments the launch assist valve 94 is capable of variety of intermediate positions which throttle or restrict amount of fluid that may flow through it when it is set between a fully open fully closed position. In some instances, it may be desirable to provide additional pressurized fluid to the hydraulic motor 77 than can be generated by pumps 36 and 76 or in some situations it may merely be desirable to provide additional pressurized fluid to the motor 77 without requiring additional energy to be expended in pumps 36 and 76 in order to achieve better economy. In such instances, the launch assist valve 94 may be set to a full or partial open position to allow pressurized fluid to flow from the accumulator 92 through the launch assist valve 94 and through a check valve 96 to the motor 77. Such an instance may occur when the machine 10 is at a dead stop position and requires additional pressurized fluid in order to start rolling, or when the motor 77 is under a heavy load. Other conditions may also be appropriate for using pressurized fluid stored in the accumulator 92. The check valve 96 can be used to ensure that fluid does not flow back through the launch assist valve 94 back in the direction towards the accumulator 92.

In some embodiments, it may also be desirable to provide pressurized fluid to the pump 76 in order to increase the ability of the pump 76 to generate pressurized fluid. For example, if pressurized fluid from the accumulator 92 was presented at the inlet 78 of pump 76 rather than requiring pump 76 to draw fluid up from the sump 38 the output of pump to 76 can be increased.

A pump boost valve 98 can be placed downstream from the accumulator 92 so that fluid stored at pressure in the accumulator 92 can be delivered, when desired, to the inlet 78 of pump 76. The pump boost valve 98 can achieve of several positions between a fully open position and a closed position. The pump boost valve 98 may be controlled by the controller 84 and connected to the controller 84 via the controller connection 86.

To ensure that fluid coming from the pump boost valve 98 goes to the inlet 78 of the pump 76, and not simply to the sump 38, a pump inlet tank check valve 100 may be installed between the sump 38 and the pump boost valve 98. The check valve 100 will allow fluid to be drawn up from the sump 38 and flow through the check valve 100 as needed by pump to 76 but will not allow fluid to flow through the check valve 100 to the sump 38.

Some embodiments in accordance with the present disclosure may also provide a way for fluid coming from pump to 76 to be quickly unloaded to the sump 38. This may be desired in situations where the brake valve 62 is quickly put into a closed position in order to brake the hydraulic motor 77. In such instances, fluid coming from the pump 76 may still be entering the hydraulic circuit 30 as the pump 76 may require some time in order to slow down and stop. Rather than overloading the circuit 30 with fluid before the brake valve 62, the pump unloader valve 101 may be placed in the circuit 32 to provide a fluid connection to the sump 38. The pump unloader valve 101 may open and provide a pathway for fluid coming from the pump 76 as it is winded down during a braking operation to flow to the sump 38. The pump unloader valve 101 may be operatively controlled by the controller 84 via the control connections 86. The pump unloader valve 101 may operate as a variety of positions between a fully closed position as shown in FIG. 3 and an open position where fluid coming from pump 76 to may flow into the sump 38.

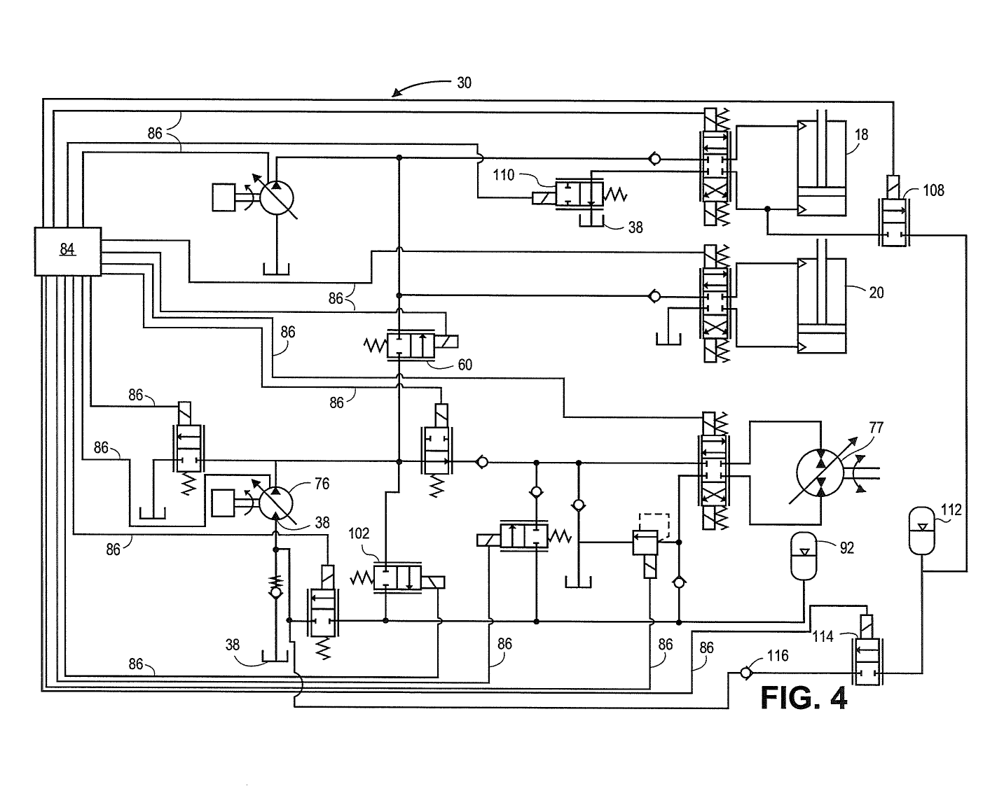

FIG. 4 illustrates a hydraulic circuit 30 in accordance with another embodiment of the disclosure. The circuit 30 shown in FIG. 3 is similar to that shown and described with respect to FIGS. 2 and 3. However the circuit 30 shown in FIG. 4 includes additional components providing additional features and capabilities. The additional features and capabilities will be described below however those features and capabilities already described with respect to FIGS. 2 and 3 will not be described again for the sake of brevity.

FIG. 4 shows an accumulator charge valve 102 operatively connected into the accumulator 92. The accumulator charge valve 102 may be operatively connected to the controller 84 via the controller connection 86. The accumulator charge valve 102 may be able to move between a variety of positions between fully closed as shown in FIG. 4 and a fully open. When opened, the accumulator charge valve 102 allows fluid to flow to the accumulator 92 to charge the accumulator 92. In some embodiments, charging of the accumulator 92 may be done with fluid flowing out of the hydraulic motor 77 when the hydraulic motor 77 is coasting or is operating under other conditions.

FIG. 4 is an example hydraulic circuit 30 that permits fluid exiting the lift cylinder 18 to flow through the end implement hybrid charge valve 108 and charge a second accumulator or implement hybrid energy storage device 112. Fluid coming out of the lift cylinder 18 may flow to the tank or sump 38 via a implement hybrid tank valve 110. The hybrid implement tank valve 110 provides a selective fluid pathway from the lift cylinder 18 to the sump 38. The implement hybrid tank valve 110 may be operatively connected to the controller 84. The implement hybrid tank valve 110 may be able to move between a variety of positions between fully closed and fully open. When opened, the implement hybrid tank valve 110 allows fluid from the lift cylinder 18 to flow to the sump 38. However, if it is desired to not send the fluid to the sump 38 but rather preserve supply of pressurized fluid to the implement hybrid tank valve 110 may move to a closed position has controlled by the controller 84 thus forcing fluid exiting the lift cylinder 18 to flow through the implement hybrid charge valve 108.

Such a circuit 30 may be useful where an implement 16 is a bucket 19 (see FIG. 1) or some other type of implement 16 that can store a large amount of potential energy. For example, in some instances, the bucket 19 may be filled with a material and raised to a high level. When an operator desires to lower the bucket 19 hydraulic fluid will exit the lift cylinder 18. Because of the high amount of potential energy stored with a full bucket 19 at a raised level it may be desirable to recapture and/or store some of that potential energy.

The circuit 30 as shown in FIG. 4 may convert some of the potential energy stored in a full and raised bucket 19 to stored pressurized fluid in the accumulator 112. As the bucket 19 is lowered fluid exits the lift cylinder 18 and through the implement hybrid charge valve 108 into the accumulator 112. The implement hybrid charge valve 108 may be operatively connected to the controller 84 via the controller connection 86. The implement hybrid charge valve 108 may be able to move between a variety of positions between fully closed as shown in FIG. 4 and a fully open. When opened, the implement hybrid charge valve 108 allows fluid from the lift cylinder 18 to flow to the accumulator 112. Thus it may charge the accumulator 112 by movement of implements 16 particularly when the implement 16 is moved by gravity or inertia to move pressurized fluid out of the implement cylinder 18.

The implement hybrid discharge valve 114 provides selective fluid access to the remainder of the circuit 30 via a check valve 116. Fluid exiting the implement hybrid discharge valve 114 flows through the check valve 116 and may be presented to the inlet 78 of pump 76 or can flow through the check valve 100 to the sump or tank 38.

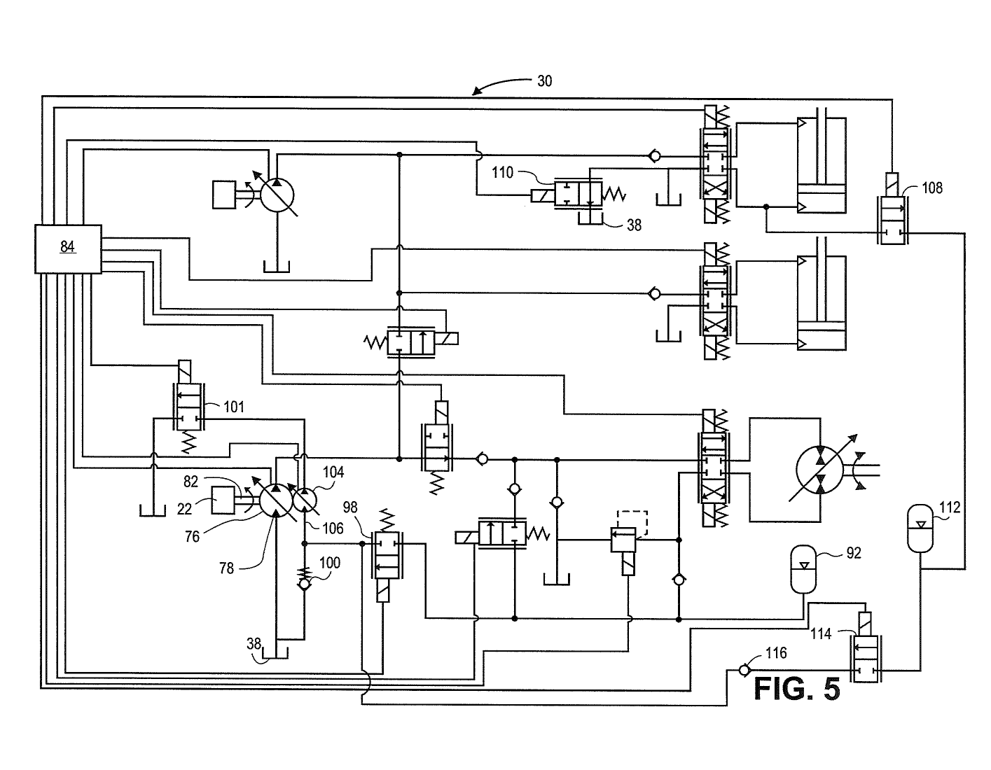

FIG. 5 illustrates a hydraulic circuit 30 in accordance with another embodiment of the disclosure. The circuit 30 shown in FIG. 5 is similar to that shown and described with respect to FIGS. 2-4. However the circuit 30 shown in FIG. 5 includes additional components providing additional features and capabilities. The additional features and capabilities will be described below however those features and capabilities already described with respect to FIGS. 2-4 will not be described again for the sake of brevity.

FIG. 5 shows an alternate configuration for a hydraulic circuit 30 similar to that shown in FIG. 4. In some instances, hydraulic pumps such as the pump 76 are not designed to have pressurized fluid at the inlet 78 and therefore cannot tolerate pressurized fluid being presented at the inlet 78. In such instances, a supplemental pump or secondary pump 104 which can tolerate receiving pressurized fluid at its inlet 106 may be coupled to pump to 76. The pressurized fluid received through the pump boost valve 98 and originating in the accumulator 92 is presented at the inlet 106 of the supplemental pump 104. Upon receiving the pressurized fluid supplemental pump 104 will turn pump 76. This can be useful to start the engine 22 with the hydraulic circuit 30. In some instances the engine 22 associated with the machine 10 may have stopped. Rather than using a typical starter associated with the engine 22 pressurized fluid contained in the accumulator 92 may be controlled to flow through the pump boost valve 98 and flow into the inlet 106 of the secondary pump 104 which will drive the pump 76 which will, in turn, rotate the drive shaft 82 and can start the engine 22. One of ordinary skill the art will understand after reviewing this disclosure that the embodiment illustrated in FIG. 4 will also have the capability of using the hydraulic circuit 30 to start the engine 22 in a similar manner to that described above with respect to FIG. 5 without necessitating a supplemental pump 104.

In other instances, the secondary pump 104 can be used not only to start the engine 22 but may also be used to perform (and supplement) typical functions of pump 76 (such as supplying pressurized fluid to the circuit 30). The inlet tank check valve 100 may be moved to be near the inlet 106 of the secondary pump 104 as shown in FIG. 5 to reduce the likelihood of pressurized fluid coming from the accumulator 92 to simply dumped into the sump 38. The secondary pump 104 may also be operatively connected to the pump unloader valve 101 as shown for reasons similar as discussed above for connecting the pump 76 to the pump unloader valve 101.

### INDUSTRIAL APPLICABILITY

Various aspects of the present disclosure provide a hydraulic circuit 30 for a machine 10 that may provide efficiency along with increased capability with respect to conventional systems. Various embodiments in accordance of the present disclosure may provide hydraulic circuits 30 having a multitude of functions. For example some hydraulic circuits 30 in accordance of the present disclosure provide a combined actuator or implement hydraulic circuit 32 and propulsion hydraulic circuit 34. The propulsion hydraulic circuit 34 may be an open system yet provides capability for braking the hydraulic motor 77. By combining the implement hydraulic circuit 32 and the propulsion hydraulic circuit 34 the pumps 36, 76 do not need to be sized as large as of the systems having separate implement 32 and drive 34 circuits. For example, because the circuits 32, 34 are combined, the hydraulic motor 77 can receive pressurized fluid from both the pump 36 associated with the implement circuit 32 and the pump 76 associated with the propulsion circuit 34. As result, the pump 76 associated with the propulsion circuit 34 need not be sized to provide capacity for maximum need of the hydraulic motor 77. Rather the pump 36 associated with the implement circuit 32 together with the pump 76 associated with the propulsion circuit 34 need only be sized to provide fluid for maximum need of the hydraulic motor. As result, smaller and less expensive components may be used in a combined circuit 30 in comparison to a system where both circuits are separate.

Furthermore, some embodiments of the hydraulic circuit 30 described herein provides capability of storing pressurized hydraulic fluid. This storage capacity adds the capability of reinserting pressurized hydraulic fluid in the hydraulic circuit 30 during times of need therefore requiring less energy to be expended from the pumps 36, 76 and also allowing the circuit 30 to use smaller pumps 36, 76 because the circuit 30 can rely on stored pressurized fluid rather than needing to generate all the required fluid with the pumps 36, 76. Using a combined implement actuation and propulsion circuit 30 permits potential energy that would normally be wasted by throttling pressurized fluid into a sump 38 during the lowering of a raised bucket 19 to be stored in the energy storage device 112 in the form of pressurized fluid. As discussed above, when a loaded bucket 19 is lowered pressurized fluid from the lift cylinder 18 can be moved and stored in the energy storage device 112 rather than being lost into the sump 38. Some embodiments will also permit excess fluid in the drive circuit 34 to be stored in the accumulator 92. In addition, in some embodiments a hydraulic circuit 30 having a pressurized fluid storage capability allows the hydraulic circuit 30 to start the engine 22 associated with the machine 10 by using pressurized hydraulic fluid stored in the accumulators 92 and/or 112 to turn the pump 76 which will in turn start the engine 22.

As result, various systems implementing aspects of the present disclosure may enjoy benefits such as a more efficient system, a system using smaller and less expensive components such as pumps, a hydraulic system that may be able to start a machine's engine, or combinations thereof. Various systems implementing aspects of the present disclosure may also enjoy other advantages and efficiencies consistent with hydraulic systems described and claimed herein.

We claim:

1. A hydraulic system for a machine, comprising:
an implement circuit including:
a first pump configured to provide a hydraulic fluid to the implement circuit; and
at least one hydraulic implement configured to be operated by the hydraulic fluid; and
a propulsion circuit including:
a second pump configured to provide the hydraulic fluid to the propulsion circuit;
a hydraulic motor operably connected to the second pump;
a brake valve operably connected to the second pump, the brake valve configured to adjust an amount of the hydraulic fluid provided to the hydraulic motor;
a back pressure valve operably connected to the brake valve and the hydraulic motor, the back pressure valve being configured to restrict an amount of the hydraulic fluid flowing from the hydraulic motor and through the back pressure valve to increase a pressure at an inlet to the back pressure valve and an outlet of the hydraulic motor during a deceleration condition; and
a combiner valve connected to both the implement circuit and the propulsion circuit, the combiner valve being configured to effect selective fluid communication between the implement circuit and the propulsion circuit.

2. The system of claim 1, further comprising an accumulator configured to store the hydraulic fluid discharged from the at least one hydraulic implement and attached to the system to selectively provide the hydraulic fluid to an inlet of the second pump.

3. The system of claim 1, further comprising an accumulator fluidly connected to the hydraulic motor and configured to store fluid discharged from the motor.

4. The system of claim 3, wherein the accumulator is further configured to store fluid discharged from the motor at substantially the same pressure of the fluid was discharged.

5. The system of claim 4, further comprising a launch assist valve configured to selectively fluidly connect the accumulator with an input to the hydraulic motor.

6. The system of claim 5, further comprising a check valve configured to prevent fluid from the accumulator to flow into the hydraulic motor without flowing through the launch assist valve.

7. The system of claim 3, further comprising a pump boost valve configured to selectively provide fluid communication between the accumulator and the second pump.

8. The system of claim 3, further comprising a pump unloader valve configured to selectively provide fluid communication between a discharge port of the second pump to a low-pressure reservoir.

9. The system of claim 3, further comprising a check valve located downstream from a launch assist valve on the side opposite the launch assist valve that receives fluid from the accumulator.

10. The system of claim 3, further comprising an accumulator charge valve configured to selectively provide fluid communication between 1) at least one of the implement circuit and the second pump, and 2) the accumulator, wherein the accumulator charge valve is configured to send the fluid to the accumulator for storage.

11. The system of claim 3, further comprising a third pump having an inlet in fluid communication with at least one of the low-pressure reservoir and the accumulator via a pump boost valve.

12. The system of claim 1, wherein the combiner valve is further configured to open to divert at least a portion of the hydraulic fluid provided by the first pump to the propulsion circuit when the second pump is unable to provide enough pressurized fluid as required by the propulsion circuit.

13. The system of claim 1, wherein the combiner valve is further configured to open to divert at least a part of the hydraulic fluid circulating in the propulsion circuit to the implement circuit to operate at least one of the implements at least in part by hydraulic fluid from at least one of: an accumulator and the second pump.

14. The system of claim 1, wherein the at least one hydraulic implement includes at least one of: a lift cylinder and a tilt cylinder.

15. The system of claim 1, wherein the machine is a wheel loader.

16. The system of claim 1, further comprising an controller operatively connected to and configured to control the first and second pumps, a directional valve associated with the hydraulic motor, a valve associated with at least one hydraulic implement, the combiner valve, the brake valve, and back pressure valve.

17. The system of claim 1, wherein the combiner valve is configured as one of a proportional-2/2 way valve and an on/off valve.

18. A hydraulic system for a machine comprising:
an implement circuit including:
a first pump configured to provide hydraulic fluid to the implement circuit;
at least one hydraulic implement configured to be operated by the hydraulic fluid;
a propulsion circuit including:
a second pump configured to provide the hydraulic fluid to the propulsion circuit;
a hydraulic motor operably connected to the second pump;
a brake valve operably connected to the second pump, the brake valve configured to adjust an amount of hydraulic fluid provided to the hydraulic motor;
a back pressure valve operably connected to the brake valve and hydraulic motor, the back pressure valve configured to restrict an amount of the hydraulic fluid flowing from the hydraulic motor and through the back pressure valve of fluid to increase a pressure at an inlet to the back pressure valve and an outlet of the hydraulic motor during a deceleration condition;
an accumulator operatively connected to the implement and propulsion circuits and configured to store the hydraulic fluid from at least one of the implement and propulsion circuits, wherein the accumulator is operatively connected to an engine starting device to provide hydraulic fluid to the engine starting device to rotate the engine starting device to thereby rotate a driveshaft attached to at least one of the first and second pumps and rotation of the driveshaft will cause an engine associated with the machine to start; and
a combiner valve connected to both the implement circuit and the propulsion circuit, the combiner valve being configured to effect selective fluid communication between the implement circuit and the propulsion circuit.

19. The system of claim 18, wherein the engine starting device includes at least one of the first pump and the second pump.

20. A machine having a hydraulic system, comprising:
an implement circuit including:
a first pump configured to provide hydraulic fluid to the implement circuit;
at least one hydraulic implement configured to be operated by the fluid;
a propulsion circuit including:
a second pump configured to provide the fluid to the propulsion circuit;
a hydraulic motor operably connected to the second pump;
a brake valve operably connected to the second pump, the brake valve configured to adjust an amount of hydraulic fluid provided to the hydraulic motor;
a back pressure valve operably connected to the brake valve and hydraulic motor, the back pressure valve configured to restrict an amount of the hydraulic fluid flowing from the hydraulic motor and through the back pressure valve to increase a pressure at an inlet to the back pressure valve and an outlet of the hydraulic motor in a deceleration condition;
an accumulator operatively connected to the implement and propulsion circuits and configured to store fluid flowing out of a cylinder associated with at least one hydraulic implement as the at least one hydraulic implement is lowered; and
a combiner valve connected to both the implement circuit and the propulsion circuit, the combiner valve being configured to effect selective fluid communication between the implement circuit and the propulsion circuit.
